(19) United States
(12) Patent Application Publication
(10) Pub. No.: US 2019/0090434 A1
(43) Pub. Date: Mar. 28, 2019

(54) System and Methods for Thermal Root Regulation and Expansive Root Growth of Growing Plants

(71) Applicant: Richard James BAILEY Jr., Kailua-Kona, HI (US)

(72) Inventor: Richard James BAILEY Jr., Kailua-Kona, HI (US)

(21) Appl. No.: 16/097,221

(22) PCT Filed: May 9, 2017
(86) PCT No.: PCT/US2017/031823

§ 371 Date: Oct. 26, 2018

Related U.S. Application Data
(63) Continuation of application No. 62/334,371, filed on May 10, 2016.

(51) Int. Cl. A01G 9/24; A01G 7/02; A01G 9/02

(52) U.S. Cl. CPC A01G 9/24; A01G 9/02; A01G 7/02

(57) ABSTRACT

A method and system for growing a plant, the method comprising: exposing a plant to water, growing medium and air; wherein the plant comprises a set of roots and the set of roots are located in the growing medium which is in a plant growth vessel, the plant growth vessel is located within an outer vessel, and a cooling medium is present in a space between an outer wall of the plant growth vessel and a containment wall of the outer vessel, and the cooling medium is in thermal communication with the growing medium through the outer wall, and the plant includes a set of roots and the set of roots are isolated from the cooling medium.

### CROSS-REFERENCE TO RELATED APPLICATIONS

This application claims the benefit and the priority of U.S. Provisional Patent Application 62/334,371, entitled “System and Methods for Thermal Root Regulation and Expansive Root Growth of Growing Plants”, and filed on May 10, 2016, the disclosure of which is incorporated herein by reference in its entirety.

### TECHNICAL FIELD

The present invention system relates to growing plants such, as vascular plants, in planting medium, such as soil or other growing medium, contained in vessels contacting a cooling medium, such as by dipping or floating the vessels in a fluid reservoir that is thermally regulated and that can in some embodiments encourage expansive root growth and development, such as growth to the inside surface of the vessels and can improve nutrient utilization and moisture uptake.

### BACKGROUND

Manipulating the root zone temperature can impact plant growth. Without wishing to be limited by theory, it is believed that simulating the onset of spring temperatures for temperate latitudes or other areas can result in a period of visually observable rapid growth in plants. In some cases, it can be observed that on the onset of the spring season in temperate regions daytime soil temperatures can be as much as 10-15° F. cooler than the ambient air temperature. During the spring season the daylight length increases and so does corresponding average air temperature towards summer season. The soil temperature in the top 3 feet during the summer months in temperate regions is closer to the average air temperature and thus at a lesser differential than that of the spring season. Some plants, such as some annual plants, including those in temperate regions, can exhibit rapid growth in the spring season and in some cases die back during the increased air temperatures and/or drier soil conditions of summer months. Some of these plants are often referred to as “cool season plants”. Some cool season plant crops are well known in the agriculture industry for growing rapidly in spring but are early to bolt or produce flowers and seed in warm weather conditions. Technology can be used in agriculture artificially simulate ideal growing conditions in greenhouses and extend the growing period for many crops, and can even manage a year round growing capability such as by controlling air temperature and circulation, humidity and carbon dioxide levels to optimize specific plant growth. Additionally soilless agricultural systems, such as hydroponic systems, can be implemented. Hydroponic systems while efficient in utilizing water resources still require an adequate source of water for operations and require close monitoring and management of the systems for fluid nutrient levels to maintain good plant growth and health. In addition, hydroponically grown crops MAY not qualify for organic certification at least because of their use of inorganic fertilizers and additives.

Both water utilization/conservation and organic certification are significant issue in agriculture. There is a need for systems and methods that can grow crops, cool weather crops, including organic crops, in non-conventional locations, such as in warmer climates and in tropical and arid regions, and for extending the growth period of cool weather crops for longer growing periods including year round production.

### SUMMARY

In a first aspect, a method of growing a plant is provided. The method comprising: exposing a plant to water, soil or solid growing medium and air; wherein the plant comprises a set of roots and the set of roots are located in the soil or solid growing medium which is in a plant growth vessel, the plant growth vessel is located within an outer vessel, and a cooling medium is present in a space between an outer wall of the plant growth vessel and a containment wall of the outer vessel, and the cooling medium is in thermal communication with the soil or solid growing medium through the outer wall, and the plant includes a set of roots and the set of roots are isolated from the cooling medium.

In a second aspect, a system for growing a plant is provided. The system comprising: a plant rooted in soil or solid growing medium; the soil or solid growing medium contained in a plant growth vessel; and the plant growth vessel located in an outer vessel; wherein a cooling medium is located within the outer vessel and in contact with an outer wall of the plant growth vessel, the outer vessel, plant growth vessel and the cooling medium configured to cool the soil or solid growing medium and a root of the plant through the outer wall of the plant growth vessel, and the outer wall configured to prevent contact of the cooling medium and the soil or solid growing medium.

In a third aspect, a method of directing root growth is provided. The method comprising: growing a plant in a growing medium in a vessel; subjecting the growing medium to a temperature gradient wherein the temperature gradient is in a direction of desired root growth.

In a fourth aspect, a method of growing a plant is provided. The method comprising: exposing a plant to water, growing medium and air; wherein the plant comprises a set of roots and the set of roots are located in the growing medium which is in a plant growth vessel, the plant growth vessel is located within an outer vessel, and a cooling medium is present in a space between an outer wall of the plant growth vessel and a containment wall of the outer vessel, and the cooling medium is in thermal communication with the growing medium through the outer wall, and the plant includes a set of roots and the set of roots are isolated from the cooling medium

In a fifth aspect, a system for growing a plant is provided. The system comprising: a plant rooted in growing medium; the growing medium contained in a plant growth vessel; and the plant growth vessel located in an outer vessel; wherein a cooling medium is located within the outer vessel and in contact with an outer wall of the plant growth vessel, the outer vessel, plant growth vessel and the cooling medium configured to cool the growing medium and a root of the plant through the outer wall of the plant growth vessel, and the outer wall configured to prevent contact of the cooling medium and the growing medium

### BRIEF DESCRIPTION OF THE DRAWINGS

FIGS. 1-8 show various embodiments and views of vessels and multi-plant vessels.

FIGS. 9-10 show various depictions of plants in vessels.

FIGS. 11-12 show growth medium after removal from a vessel.

FIGS. 13-17 show plants in vessels in reservoirs.

FIG. 18 shows vessels/multi-plant vessels in reservoirs with an outer cover.

FIGS. 19-20 are side views of a multi-plant vessel in a reservoir.

FIGS. 21-22 are perspective and side views of a multi-plant vessel.

FIG. 23 is a perspective view of a multi-plant vessel with growth medium and plants.

FIG. 24 is an end view of a multi-plant vessel.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

The present disclosure describes methods and systems that can enhance plant growth, such as by encouraging the direction of plant root growth toward a thermally modified surface, such as a cooled surface. A plant growing medium, such as soil, gel, hydroponic fluid, compost, planting mix, plant tissue culture medium, etc., can be placed in vessels and the vessels can be placed in contact with a cooling medium or device. In some embodiments, a solid growing medium can be used, meaning a growing medium which is not a hydroponic fluid, and can in some embodiments be a particulate material. In some cases, the cooling medium or cooling device can be located within the wall of the vessel or can pass within or through the wall of the vessel. In some embodiments, cooling devices can comprise or consist of a heat exchanger, a Peltier device, a heat pump, a refrigeration cycle chiller, an absorption cooler or an evaporative cooler. In some embodiments, the plant growing medium can act as ballast for the vessels, and the vessels can in some embodiments float in or on the cooling medium. In some embodiments, the growing medium can be selected to allow gasses released from the soil to pass freely out of the plant growth vessel. In some embodiments, the vessel can be surrounded or partially surrounded by cooling medium. In some embodiments, the vessels outer wall can be in direct contact with the cooling medium. In some embodiments, vessels can be immobilized or restricted in movement, such as by contact with other vessels and/or by contact with a portion of a reservoir containing the cooling medium, such as the bottom, a side or a cover or lid or a bracket affixed to the bottom, a side or a cover or lid. The cooling medium can be temperature controlled or not.

The plant growing medium placed in the vessels can have direct contact with the vessel inner wall. In some embodiments, the vessel's inner wall surface region directly adjacent to the vessels outer wall surface region with direct contact with the cooling medium can have the greatest or fastest heat exchange. In some embodiments, the plant growing medium, such as soil, can be in direct contact with the vessel inner wall in this region of high heat exchange. In some embodiments, the plant growing medium loses heat at an indeterminate rate and/or in an indeterminate amount of time, and approaches or achieves equilibrium with the cooling medium temperature. A thermal gradient can also exist within the plant growing medium with the lowest growing medium temperature nearest the vessel inner wall surface region directly adjacent to the vessel's outer wall surface region with direct contact with the cooling medium and plant growing medium with higher temperatures at increasing distances from the vessel inner wall. The vessel wall can be constructed to enhances or reduce thermal heat exchange potential in designated regions, such as by utilizing thinner walls and/or by utilizing materials of construction with higher thermal transmission capability, such as higher thermal conductivity. In some embodiments, the vessel walls can be the region of greatest heat flux. In some embodiments, the vessel can have regions of different temperatures, such as where the coolest temperature is located at a lower portion of the vessel or at a vessel wall, such as a central wall along the side, an upper wall along the side, a lower wall along the side, or a bottom wall of the vessel. In some embodiments, different temperatures can be achieved in the vessel by varying the thickness of the wall of the vessel or by varying the flow rate of cooling medium past different portions of the vessel in comparison to other portions of the vessel or by providing layers of different cooling temperatures (thermoclines) in the reservoir. In some embodiments, thermoclines can be created by the use of horizontal baffles in the reservoir.

In some embodiments, the temperature and/or growth conditions presented at the roots of the plant can cause the root growth of the plant to be expansive, such as by causing the root growth to be outward toward the wall of the vessel, or directed in particular direction(s). In some embodiments, the expansive root growth can take place when the temperature of at least a portion of the growing medium is reduced to below the ambient dew point temperature by 10-15° F. However, in some embodiments, it can be desirable to reduce at least a portion or substantially all of the growing medium to below the ambient dew point (measured in proximate an upper portion of the plant), by 2-5° F. or 5-10° F. or 15-20° F. In some embodiments, it can be desirable to reduce at least a portion or substantially all of the growing medium to a temperature of about 55-70° F., or about 55-65° F., or about 55-60° F., or about 60-70° F., or about 65-70° F., or about 60-70° F. or another temperature or temperature range which provides favorable growth characteristics for a particular plant. In some embodiments, guidance regarding an appropriate temperature range might be based upon a soil temperature, such as a spring soil temperature or a late spring soil temperature of a location where the plant is native or was bred or adapted to grow.

In some embodiments, the temperature, such as the temperature of the cooling medium, the temperature of the growing medium and/or the temperature difference between the dew point and the growing medium can be varied or kept constant during the day and/or during the growing cycle of the plant. For example, in one embodiment, one temperature can be used during daytime and a different temperature can be used at nighttime. In one embodiment, one temperature can be used when the plants are initially placed in vessel in a reservoir and another temperature can be used later in the growing season, such as one or more days, weeks or months later. In some embodiments, more than one temperature change can occur. In some embodiments, a portion of the growing time can be subject to control of the growing medium temperature and another period of the growing time can be subject to control of the temperature difference between the growing medium and the dew point.

In some embodiments, the system can also reduce irrigation requirements such as by reducing evaporation and the system can reduce nutrient requirements such as be reducing nutrient leaching loss by growing plants in contained vessels.

In some embodiments, the vessels prevent interaction of the cooling medium with the growing medium by creating a physical barrier between the cooling medium and the growing medium, but still allowing thermal interaction between the cooling medium and the growth medium.

In some embodiments, the vessels can be made of a plastic or a metal or an elastomer or a ceramic, such as a plastic, metal or ceramic or other material suitable for use with the cooling medium and which does not allow the cooling medium to pass through the wall of the vessel and contact the growth medium.

In some embodiments, the system and method of the present invention can be realized when the plant growing medium temperature can be regulated to produce a thermal gradient or a controlled thermal gradient between the atmospheric temperature of the cultured plant's leaf zone and the cooled root zone in plant growing medium which can enhance root growth and direction and in some embodiments reduce evaporation irrigation water loss and in some embodiments make evaporative water loses associated with each plant and its corresponding growing medium more equal between the plants. In some embodiments, the temperature characteristics of the plant growth medium can be varied to enhance root growth and/or to manipulate root growth direction, such as by layering different size or type of plant growing medium having different heat exchanging properties, such as different thermal conductivity, heat transfer film coefficient at the wall surface, heat capacity and/or water retention properties, that can result in increases or decreases in temperature for regions in the vessel. In some embodiments, different heat exchanging properties can be realized with planter medium having different degrees of porosity, such as where higher porosity provides lower heat exchanging properties than denser or less porous planter mediums. In some embodiments, the temperature difference between the atmosphere above the growing medium and the growing medium itself can be varied to reduce evaporative irrigation water loss for one, some or all plants in the system.

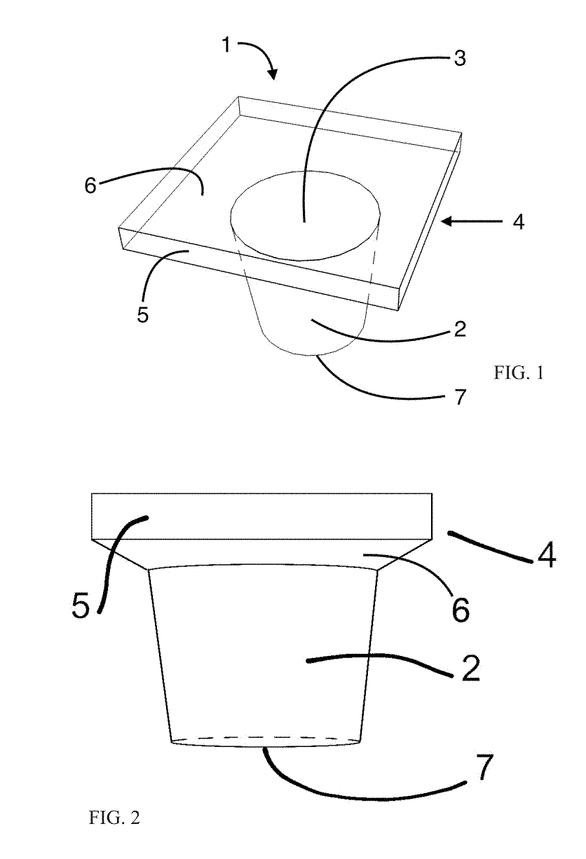

In some embodiments, vessels can be designed to float in a fluid, such as a cooling medium. The vessels can have deepened indentations of varying depth and width, as suited to various types of plants, to hold planter medium for plant root development. The vessel can be of a variety of shapes, such as a closed-bottom cylinder or an inverted cone or a truncated inverted cone. In some embodiments, the vessel can have walls with corners and/or vertical edges, such as an inverted pyramid of three, four or more sides (not counting the base), as well as truncated forms of these shapes. In some embodiments, other shapes can be used so as to provide additional heat transfer area to particular areas for root development. In some embodiments, there can be more than one vessel, and some or all of the vessels can be attached together. (See, e.g., FIGS. 1, 4, 6 and 8.).

In some embodiments, the fluid can be a thermally controlled cooling medium. In some embodiments, the fluid can be a heat transfer medium that is not controlled. In some embodiments, the fluid can be used on a single pass basis. In some embodiments, the fluid can be recirculated, such as through a heat exchanger or a temperature controlling unit, such as a chiller, a cooling tower, or a heat pump. In some embodiments, the fluid can be ocean water or deep ocean water. In some embodiments, the temperature of the cooling medium can be reduced through the use of a chiller that operates off of waste heat from a generator that also produces CO₂. In some embodiments, at least a portion of the CO₂ from the generator can routed to a location proximate a portion of the plants above the growth medium, such as an area with leaves. In some embodiments, CO₂ from an alternate source, such as a power generation system or a heating system can be routed to a location proximate a portion of the plant above the growth medium, such as an area with leaves.

In some embodiments, the vessels can be manufactured from a variety of materials. The planter vessels can be made of metallic or non-metallic material or a combination of the two materials. The planter vessels can also be constructed out of glass, ceramic, carbon fiber, plastic, elastomeric, clay, wood, metal and other compound synthetic materials as well as combinations thereof.

In some embodiments, the vessel can have an upper deck that extends upwardly or outwardly or outwardly then upwardly from the vessel and have a different shape from the vessel. In some embodiments, the upper deck can have sidewalls that are above the fluid or that are at least partially submerged and exposed to the fluid. In some embodiments, growth medium can be present in or on the upper deck. In some embodiments, additional heat transfer can occur across the sidewall and/or the bottom of the upper deck. In some embodiments, floatation material can be present in the sidewall of the upper deck and/or in the bottom of the upper deck. In some embodiments, floatation material can be present in the vessel, such as a wall of the vessel. In some embodiments, floatation material can be present within the vessel or the upper deck, such as by attaching floatation material to a surface of the vessel wall or a sidewall or bottom of the upper deck. In some embodiments, floatation material can be mixed into the growth medium. In some embodiments, floatation material can be attached to an exterior surface of the wall of the vessel or the sidewall or bottom of the upper deck.

In some embodiments, the plant growing medium contained in the planter vessel can be temperature regulated by varying the temperature of the fluid in the reservoir using the vessel walls as the heat-exchanger surface area. The plant growing medium can approach equilibrium with the reservoir temperature over a period of time. The reservoir fluid (cooling medium) temperature can be regulated in pumped recirculating closed loop configurations with heaters or chillers or in an open flow through system such as with ocean water of a suitable temperature, such as warm ocean water or cold ocean water, and in particular embodiments, the ocean water can be warm surface ocean water or cold deep ocean water. In some embodiments, surface water from a lake, river, reservoir or the like can be used. In some embodiments, reclaimed water can be used. In some embodiments, ground water can be used, such as spring water, well water, aquifer water, and the like.

In some embodiments, plants grown in proximity to a cooling medium can demonstrate directed root growth. In one embodiment, a cooling pipe, such as a pipe carrying a cooling medium of an appropriate temperature, such as common plastic irrigation piping used in agriculture or other piping or tubing or any other suitable material, or heat exchanger, can be placed in or near the root zone. The plant's roots can then grow toward the cooling pipe and form a more dense root structure in the vicinity of the cooling pipe. When cooling is achieved through a wall of the vessel, such as by contacting an outside surface of the wall with a cooling medium, the plant's roots can grow toward the wall and the roots can be distributed along the wall. In some embodiments, the vessel can be submerged or partially submerged in a cooling medium, and root development can occur toward the wall of the vessel that was submerged below the cooling medium fluid level line. The plant's root zone development can be enhanced, and in some cases greatest, nearest the inner surface of the wall of the planter vessel closer to the reduced temperature cooling medium. (By chilling the cooling medium, the growth medium becomes chilled. The growth medium can be thermal regulated by controlling the cooling medium temperature, as measured for example within the reservoir, or at an inlet or an outlet of the reservoir, and thermal regulation can be accomplished, for example, with a packaged chiller system, a cooling tower, a refrigerator, etc. or by heat exchange with another cold medium such as through the use of deep ocean water. In some embodiments, a natural source of cold water can be used directly as the cooling medium, such as by using deep ocean water directly in the reservoir.)

In some embodiments, an area can exist below the soil surface that has a cooler temperature than the surface of the soil, defined as a bed of plant growing medium of either natural or synthetic origin, and the soil surface maintains a temperature that is below the dew point, water can condense on the surface and can be carried by gravity, capillary action or other means into the porous soil. As the water travels, it can become denser, due to the change in temperature, and can continue traveling to the coldest area below the soil. FIG. 12 shows an example where plant growing medium was cooler than the ambient air dew point temperature demonstrated higher moisture content. Here, plant growing medium is shown upside down to illustrate the darker moisture area near the bottom of the plant growth medium inside the vessel.

In some embodiments, the vessel bottom can terminate in a flat surface or a pointed surface or in an edge, and the roots can grow toward the walls, along the walls and toward the bottom of the vessel. In some embodiments, a hollow portion can be provided in the bottom of the vessel that results in an inner wall of the vessel where the inside surface of the inner wall is in contact with the plant growing medium and the outer surface of the inner wall is in contact with the cooling medium, and the inner wall extends upward into the growth medium and terminates in a closed upper area. Vessels that include a hollow portion can also distribute root growth toward the inner wall, down and along the inner wall and towards the bottom of the vessel. Growth of roots along walls and inner walls of vessels can result in better distributed root growth for the plant and less of a tendency for crowding of roots. In some embodiments, better distribution of roots can result in better uptake of nutrients from the plant growing medium. In some embodiments, better distribution of roots can result in better development of root crops, such as carrots, radishes, beets, celery, potatoes, rutabagas, and the like, and less of a tendency for the roots and the root crops to grow

Cooling Medium

In various embodiments, the cooling medium can be any suitable medium that is able to move heat to and/or from the vessels, growing medium and roots of the plants. Suitable cooling media can operate to move heat by way of evaporation, convection, conduction and/or condensation. In some particular embodiments, the cooling medium can comprise or be a fluid. In some embodiments, the cooling medium can comprise or be a liquid. Particular liquids of some embodiments can include water and different types of water such as treated water, sea water, well water, brackish water. Particular liquids of some embodiments can also include liquids that comprise glycol (e.g. ethylene glycol, propylene glycol, etc.) or other “antifreeze” or other cooling system material. In some embodiments, the liquid can comprise water. In some embodiments, the liquid, fluid or cooling medium can be treated, such as with a lubricant, an anti-scale agent, an anticorrosion agent, an antibacterial agent or other agent or ingredient used in treating or preserving water cooling/heating/refrigerating systems and combinations thereof.

Vessels

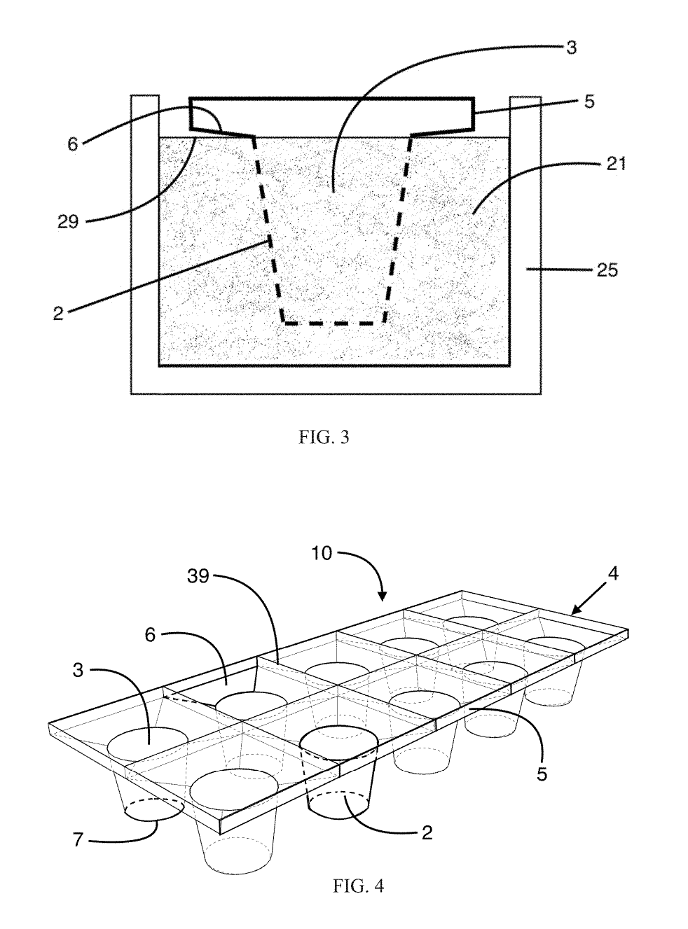

FIGS. 1-3 show embodiments of a single vessel 1. In FIGS. 1-3 can be seen a vessel interior 3 surrounded by a wall 2 with an optional upper deck 4 extending from an upper portion of the wall 2 with an optional sidewall 5 extending upward from the bottom of the upper deck 6. Not shown is the bottom 7 portion of the wall 2 closing the bottom of the vessel.

In various embodiments, the vessel can have a circular, square, angular or other appropriate shape. Various aspect ratios for the vessel can be used, such as one where the height is smaller than, equal to or larger than the diameter. In addition, the vessel can have a common shape or a frustoconical shape or can be square, rectangular or angular with sloped walls. The bottom of the upper deck 6 can be flat or it can be sloped, such as where the junction of the upper deck 4 with the vessel 2 is lower than the junction of the bottom of the upper deck 6 with the sidewall 5. In some embodiments, the slope can be formed by flat planar regions connected together or it can be formed as a smooth and continuous slope around the surface of the bottom of the upper deck 6. In some embodiments, the side walls can form a square upper surface, as can be seen in FIG. 1. In some embodiments, the side walls can form a rectangle, and ellipse, a circle or some other shape, whether comprising straight sections, curves, or some combination thereof. In some embodiments, the vessel can provide a watertight barrier between the vessel exterior in the vessel interior 3. In some embodiments, the upper deck can provide a watertight barrier between the exterior and interior of the upper deck.

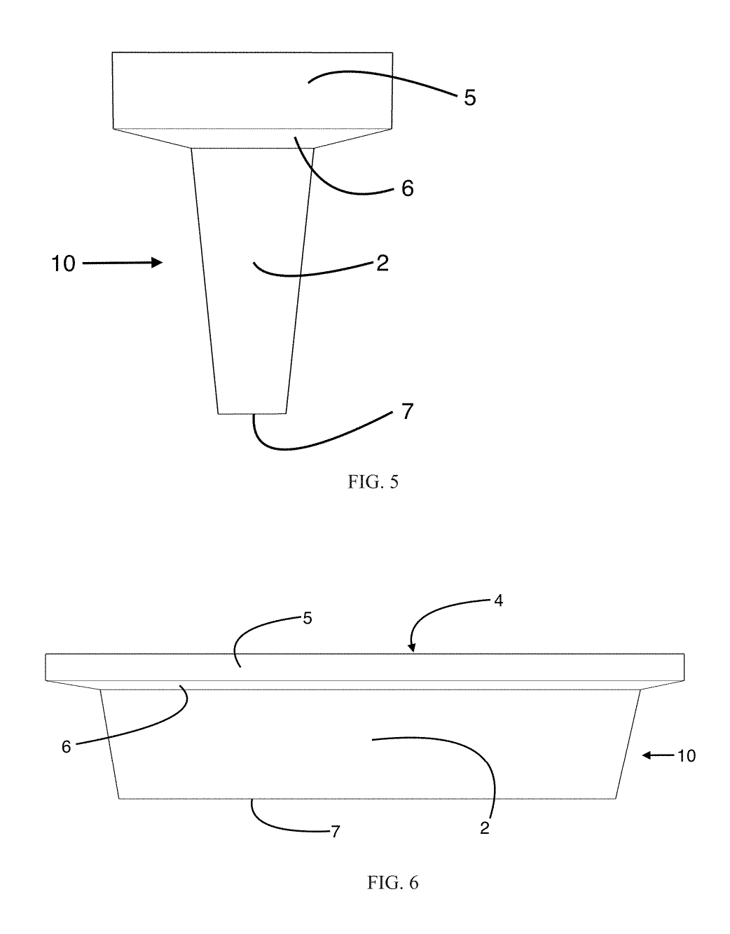

FIGS. 4-8 show different embodiments of vessels such as, a multi-plant vessel 10 having multiple vessel interiors such as 2, 3, 4, 5, 6, 7, 8 or more vessel interiors 3 configured surrounded by vessel walls 2. The upper deck, as shown in FIG. 4, can be formed to connect a number of vessel interiors 3 surrounded by vessel walls 2 and provide a single sidewall forming a perimeter around the number of vessel interiors 3 surrounded by vessel walls 2.

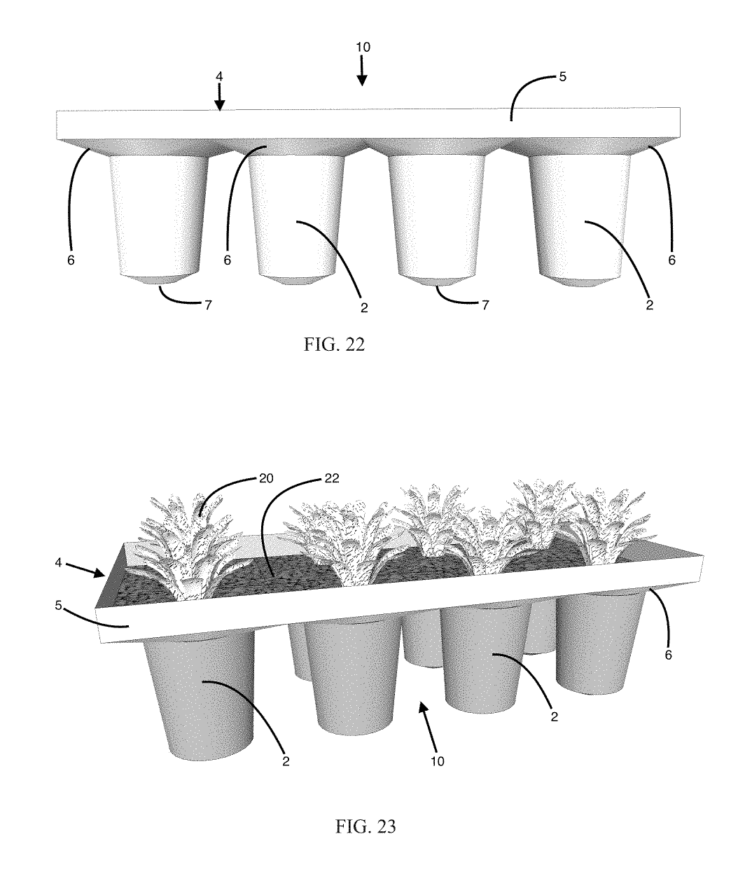

FIGS. 21, 22 and 24 show examples of multi-plant vessels. These and the other drawings disclosed herein are not to scale. Suitable widths plant cells can be any suitable size and widths can include, for example, those of 3 to 12 inches or greater. Suitable plant cell depths can be any suitable depth, depending upon the plant and the desired root growth and in some embodiments can be 3 to 18 inches or greater. Suitable sidewall heights can be any suitable height and in some embodiments can be 1 to 6 inches or greater. Suitable top deck inclination can be any suitable inclination and in some embodiments the inclination can 1 to 6 inches or greater. Suitable upper deck length can be 1 to 4 feet or greater 1 to 8 inches or greater per plant cell, and suitable upper deck width can be any suitable width and in some embodiments can be 1 inch or greater per plant cell.

In some embodiments, each vessel interior 3 surrounded by a vessel wall 2 can have a separate upper deck 4 from the other vessel interiors 3 surrounded by vessel walls 2 wherein the side walls 5 isolate sections of upper deck 4 for each vessel interior. In some embodiments, there can be a separate series of side walls 5 for each vessel interior, where adjacent sidewalls can be attached one to another. In some embodiments, a single sidewall 5 can be used to isolate separate vessel interiors 3, such as where a first vessel interior 3 is on one side of the sidewall 5 and a second vessel interior 3 is on the other side of the sidewall 5.

In some embodiments, the upper deck 4 can provide a flat or a substantially flat surface between some or all of the vessel interiors 2. In some embodiments, the upper deck 4 can provide sloped surfaces, for example that slope downward into the vessel interiors 2, and can have raised areas between vessel interiors 2.

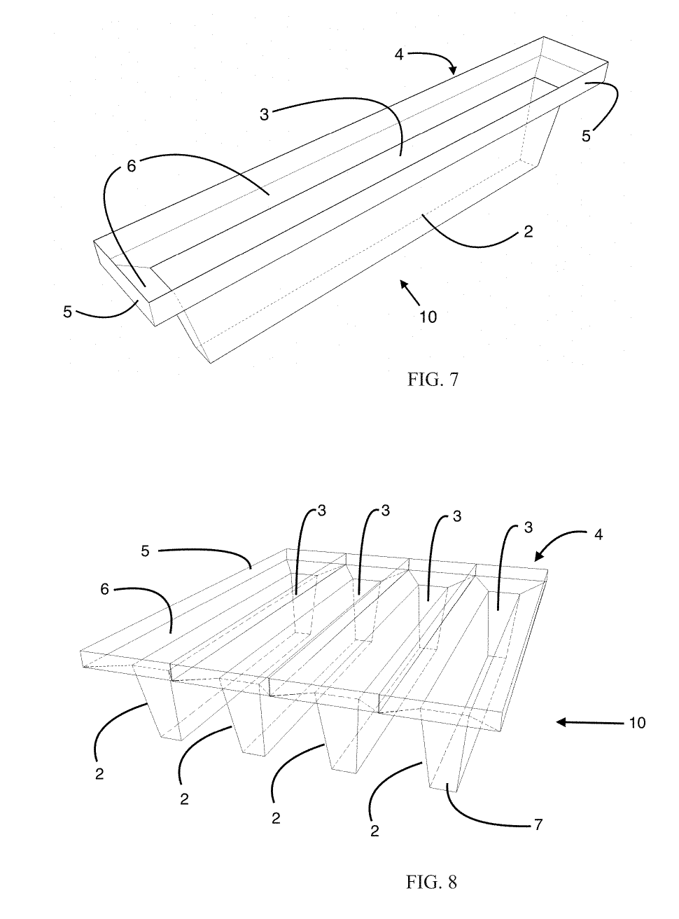

In some embodiments, for example as shown in FIGS. 6 and 7, a multi-plant vessel 10 can have a single vessel interior 3 configured to hold multiple plants, for example in a row, integrated, or in some other arrangement including a random arrangement of the plants.

FIGS. 6 and 7 show a multi-plant vessel 10 having a single upper deck encompassing the entirety of the vessel interior 3 and having a sidewall 5 forming a perimeter around the entirety of the upper deck. However in some embodiments, additional sidewalls 5 can be provided at various locations, such as forming dividers across the top of the vessel interior 3.

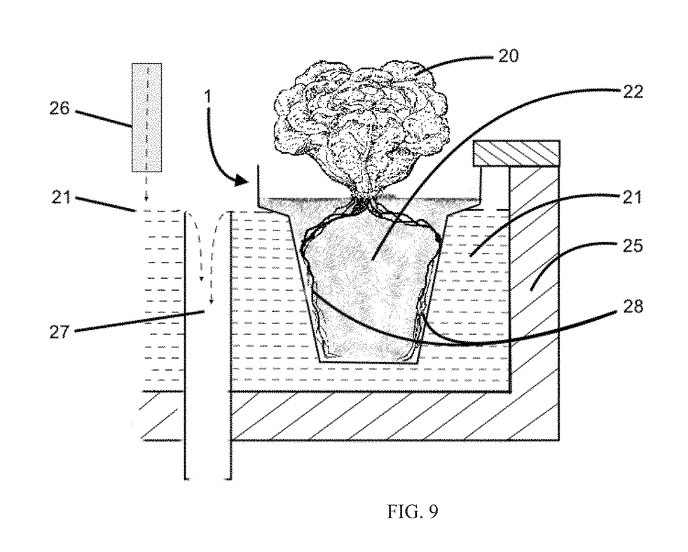

FIG. 8 shows another embodiment of a multi-plant vessel 10 which includes a series of multi-plant vessel interiors 3 connected together with a common upper deck 4 with a single sidewall encompassing all of the vessel interiors 3. In some designs, the upper deck can be sloped or it can be flat or substantially flat. In some embodiments, the upper deck can form raised portions 39 between adjacent multi-plant vessel interiors 3. In some embodiments, the slope of the bottom of the upper deck 6 can be formed by a series of flat surfaces or by a continuous surface around the vessel interior 3. In some embodiments, additional sidewalls 5 can be present and can divide sections of the vessel interior 3.

Reservoirs

FIG. 9 shows a plant 20 in a vessel 1 surrounded by a cooling medium 21. The vessel interior 3 includes growth medium 22 in which the plant 20 is rooted. The cooling medium 21 is contained by a reservoir 25. In the embodiment of FIG. 9, the cooling medium nearly fills the reservoir 25 and floats the vessel 1. A cooling medium inlet 26 and cooling medium outlet 27 are also shown. Cooling medium outlet 27 can comprise a pipe, a weir or other fluid outlet or drain and combinations thereof. In various embodiments, there can be one outlet 27 or multiple outlets 27 for a reservoir (either single plant or multi-plant.)

FIG. 19 is a side view of a reservoir 25 with multi-plant vessels 10 present in the reservoir 25. The level of the cooling medium 21 is shown at a level such that the multi-plant vessels 10 are below a vessel stop 35. Different cooling medium levels 29 can be used in the reservoir, some which float vessels 1 or multi-plant vessels 10 and some which do not. In some embodiments, the cooling medium level 29 can be at a point only reaching part way up the wall of a vessel 1 or a multi-plant vessel 10. In some embodiments, the cooling medium 21 can reach up to the top of the vessel but not encroach upon the bottom of the top deck 6. In some embodiments, gaps 38 can be formed underneath the raised portions 39 of the bottom of the upper deck 4. In some embodiments, the cooling medium level can encroach upon the bottom of the upper deck 6 and contact a portion of or all of the bottom of the top deck 6. In some embodiments, the cooling medium level can progress up the sidewall of the top deck. In some embodiments, the vessel stop can be set at a height where the vessels will be unable to float. In some embodiments, the vessel stop can be set at a position such that the vessels can float if provided with a sufficiently high cooling medium level.

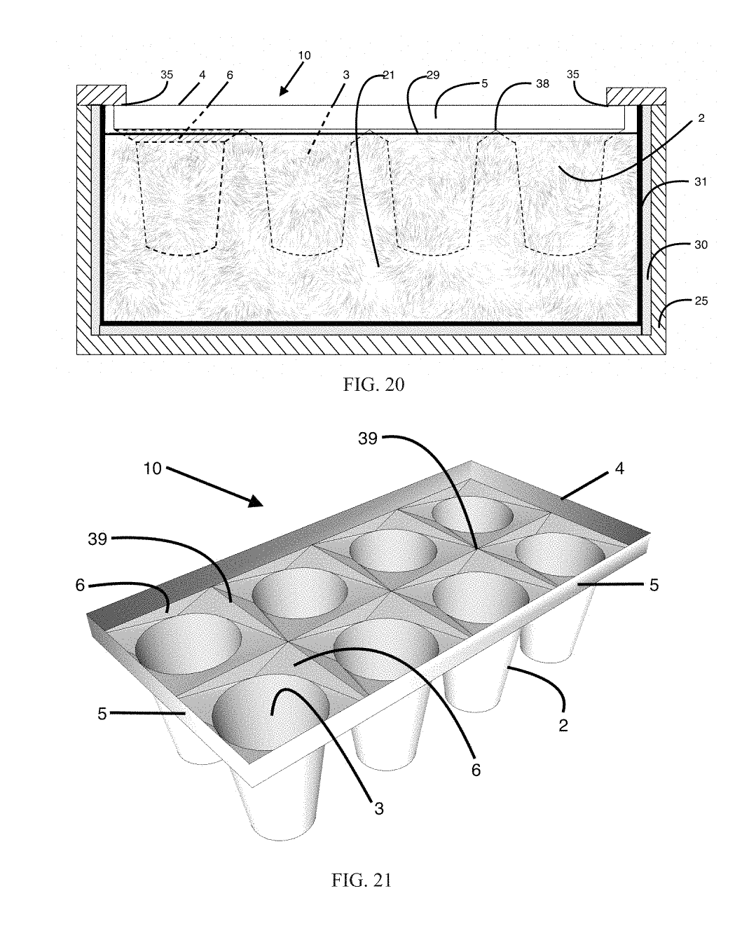

FIG. 20 shows an embodiment where the cooling medium level has been raised to a point where multi-plant vessels 10 (or vessels 1) float and contact the vessel stop. Impingement of the multi-plant vessels 10 or vessels 1 against the vessel stop can prevent further upward travel of the multi-plant vessels 10 or vessels 1. In some embodiments, the vessel stop can be provided with additional features, such as friction enhancing services and/or features which interact with the sidewall of the top deck to prevent horizontal movement of the multi-plant vessel 10 or vessel 1. In some embodiments, insulation 30 can be provided in or on the walls and bottom of the reservoir. In some embodiments, a liner 31 can be utilized within the reservoir such as to provide a watertight surface and/or to prevent growth of algae, bacteria, protozoa and the like. In some embodiments, the cooling medium can be water or treated water. Suitable treatments include those which prevent corrosion, prevent deterioration of wood, prevent microbial growth, prevent algal growth etc.

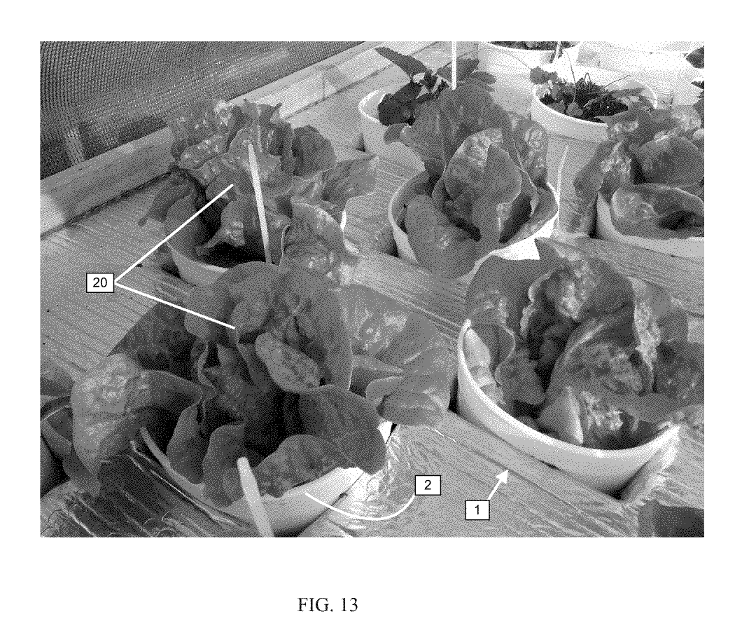

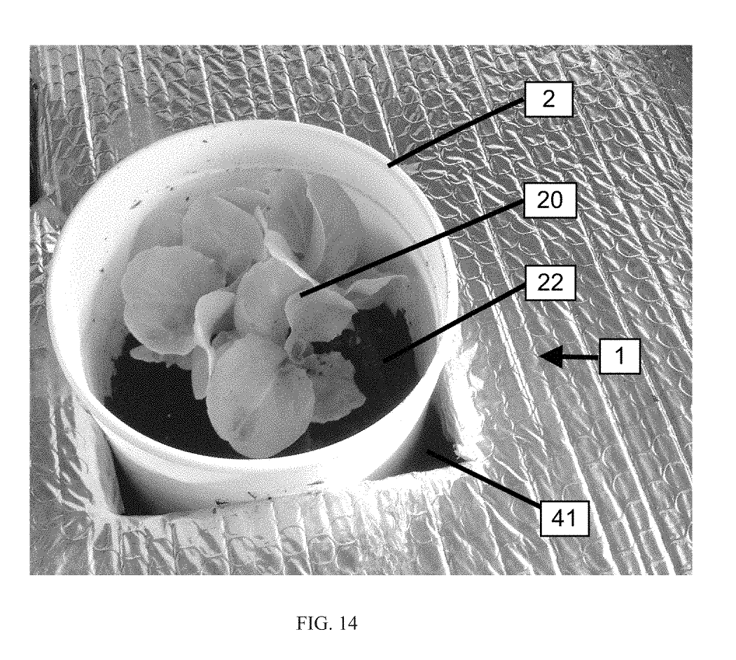

In some embodiments, such as those shown in FIGS. 13-16, a cover 40 can be positioned over the cooling medium. Suitable covers can include those which reduce or prevent evaporation and those which provide an insulating layer. In some embodiments, openings 41 can be provided through the cover 41, providing a location through which vessels 1 or multi-plant vessels 10 can be placed. Suitable vessels 1 and multi-plant vessels 10 can include those with upper decks and those without upper decks. Suitable materials for covers 40 can include plastic plate material, insulted fiberglass material, plywood or other combination of metallic and non-metallic materials that can, for example, be made to support singular or multiple planter vessels in the cooling medium. In some embodiments, the cover 40 can be in contact with the cooling media 21 and in some embodiments, the cover 40 can be located above the cooling medium 21.

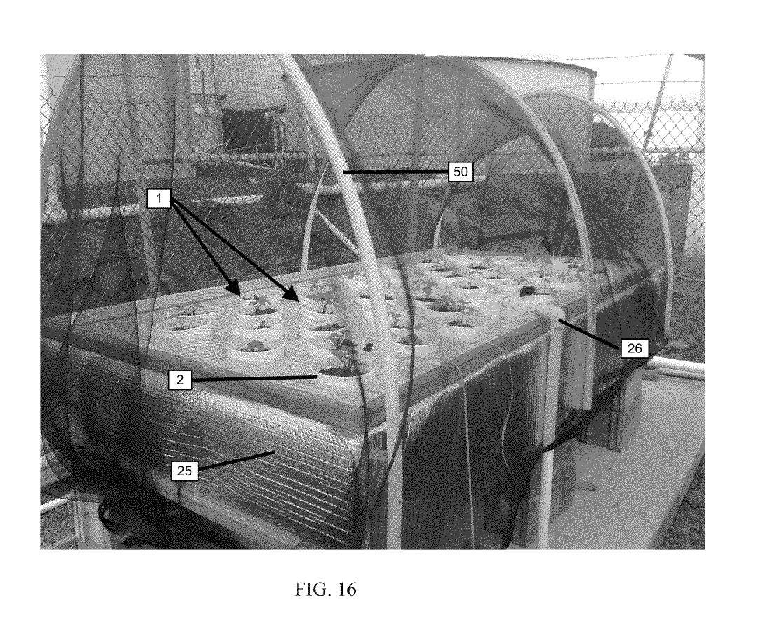

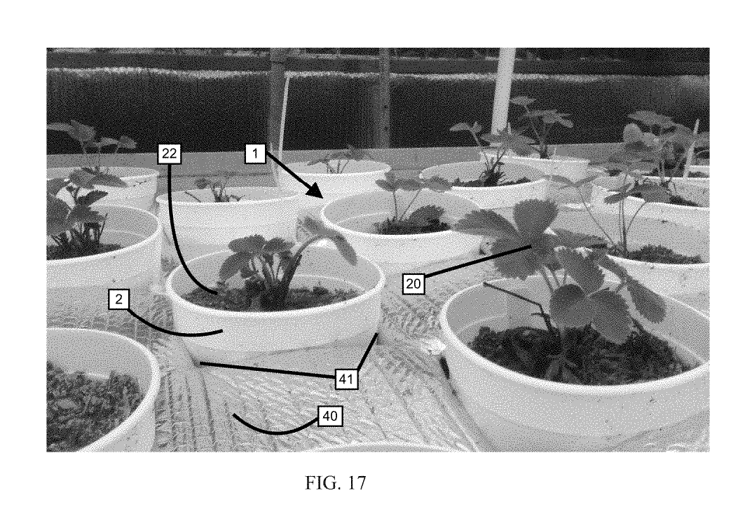

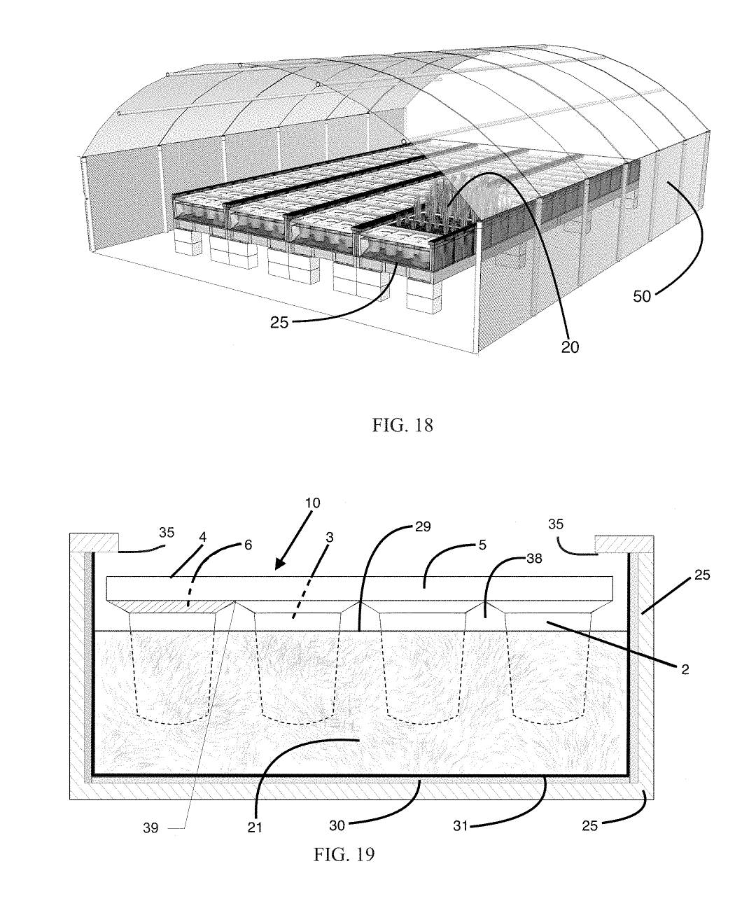

In some embodiments, such as those shown in FIGS. 16 and 18 an outer cover 50 can be positioned over one or more than one reservoir. Suitable outer covers 50 include those which can provide shade, allow transmission of at least some light, and/or exclude at least some insects and birds. In some embodiments, the cover 50 can cover the top and one or more ends of a structure enclosing the reservoirs. In some embodiments, the cover 50 can limit the flow of air from the outside into the structure being covered by the cover 50. In some embodiments, free flow of air is provided. In some embodiments, the cover 50 facilitates the buildup of humidity within the structure such as in the vicinity of the plants. In some embodiments, further features such as those which are able to modify the temperature and/or the humidity of the air in the vicinity of the plants can be included, such as coolers, air conditioners and/or evaporative coolers.

Plant Growth

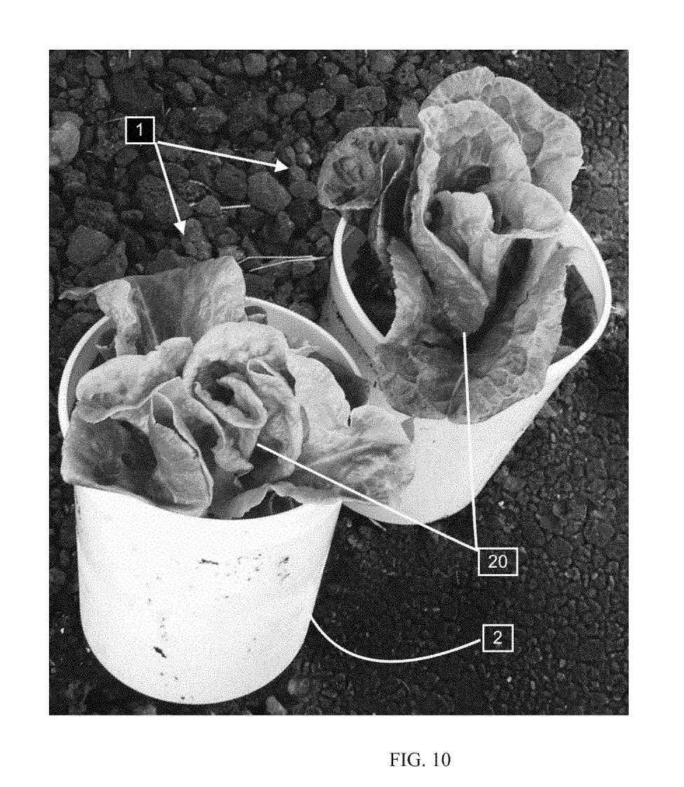

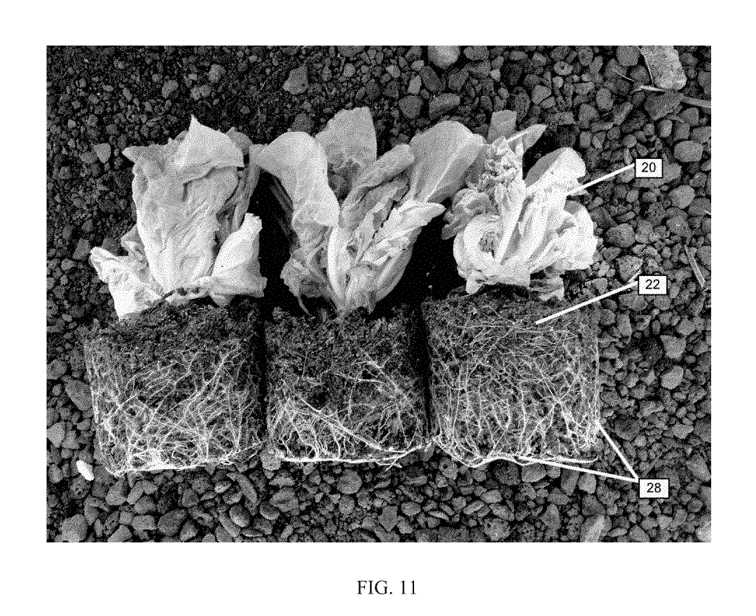

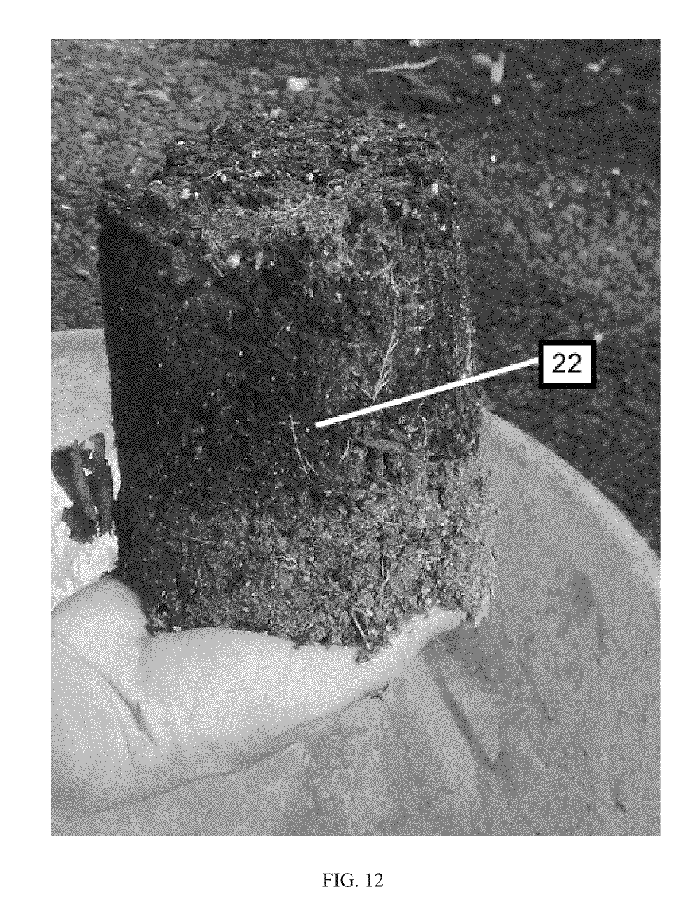

FIGS. 10 and 11 show plants that have been grown in vessels where the vessel is in contact with the cooling medium. In FIG. 11, shows the roots 28 of plants grown in vessels in contact with cooling medium. Here, root growth with heavier growth toward the bottom of the plant and extensive growth which is not root-bound being at the outside periphery of the growth medium 22 which was present in the vessel. FIG. 12 shows growth medium, removed from a vessel and turned upside down to illustrate the darker moisture area near the bottom of the growth medium inside the vessel.

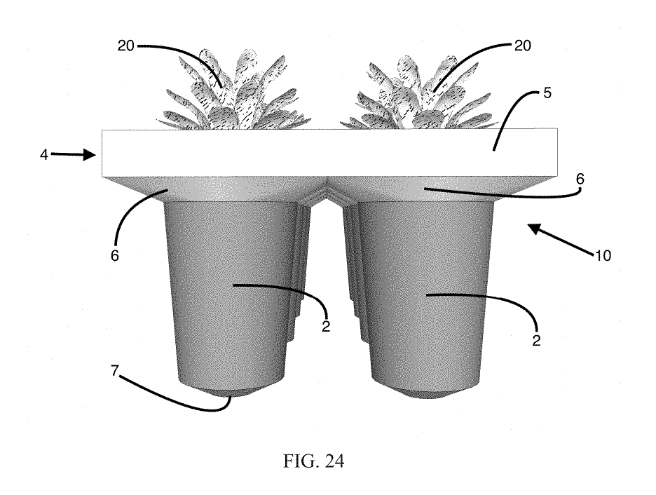

FIG. 23 is a sketch of plants been grown in a multi-plant vessel wherein the growth medium is also present in the top deck. In other embodiments, growth medium can also be present in the top deck of a vessel 1.

Layout

In some embodiments, the reservoir can be configured such that the vessels and the multi-plant vessels remain in a single location within the reservoir for the entire growth cycle. In some embodiments, the reservoir can be configured to move or relocate the vessels and the multi-plant vessels continuously or at intervals. For example, the reservoir can provide a pathway wherein the vessels and/or multi-plant vessels can be moved by action of the cooling medium having through the reservoir. In some embodiments, this movement can be combined with a change in level of the cooling medium so as to float and un-float the vessels and/or multi-plant vessels in conjunction with the movement of the vessels and/or multi-plant vessels.

In some embodiments, such as shown in FIG. 18, an outer cover can be present over reservoirs. In some embodiments, the outer cover can have an upwardly extending overhead portion that is rounded, peaked, domed, or the like. In some embodiments, an outer cover can be attached to side wall that are vertical, sloped, curved or some other shape and combinations thereof. In some embodiments, an outer cover can enclose a single reservoir. In some embodiments, an outer cover can enclose two, three, four, five, six or more reservoirs. In some embodiments, an outer cover can cover only a portion of a reservoir or only portions of two or more reservoirs or one or more entire reservoirs and one or more partial reservoirs.

In some embodiments, movement of the vessels and/or multi-plant vessels can be performed in order to facilitate different tasks being performed on the plants, the vessels or the upper decks. In some embodiments, vessels and/or multi-plant vessels can be conveyed by the cooling medium to different stations, such as stations for inspection, pest control (one or more stations for insect, animal and/or microbial control), irrigation, nutrient testing and/or addition, planting, harvesting, pruning, etc.

### EXAMPLE 1

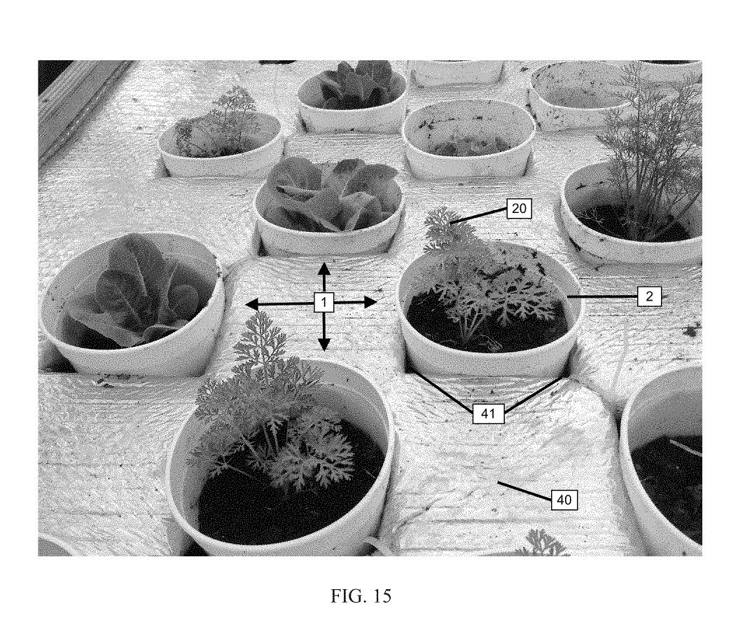

“Butter Lettuce” plants were grown in vessels as in FIG. 13 using commercially available premix potting soil used in the horticulture industry as the plant growing medium. The potting soil provided a loose, non-compacted growing medium. Single plant vessels were place into a reservoir as shown in FIG. 15 and held in place by the insulated cover with square/rectangular openings that fit the round vessels tightly. Cooling medium in the form of deep sea water at 42-46° F. was plumbed in a flow-through design to the reservoirs, with the flow rate regulated by a Supervisory Control and Data Acquisition (SCADA) system to maintain plant growing medium target temperatures by the regulating the open and closed position of valves on the incoming cooling medium deep sea water. After 6 weeks, the plants were harvested and the roots were examined. As seen in FIG. 11, the roots developed along the inner surface of the wall of the vessel, with little root development in the central portion of the growth medium, in spite of the presence of nutrients and water in the central portion of the growth medium. Water was added to the plants when needed as indicated by incipient wilting or by testing of soil moisture with a moisture probe.

This “Butter Lettuce” trial began on Oct. 20, 2013 and ended on Nov. 25, 2013 for a growth period of 37 days and took place at Keahole Point in Kailua-Kona, Hi., USA. The atmospheric seasonal conditions were typical for this region at this time of year. Exemplary conditions include: Nov. 15, 2013 at 1609 hours, the dew point temperature was 76.6° F., ambient air temperature was 84.1° F. and relative humidity was 78.4%. The plant growing medium, commercially available soil potting mix, was maintained by the SCADA system at 15-10° F. below the dew point temperature which typically resulted in a target temperature of 55-60° F. for the soil during the trial period by measuring the temperature of the soil in selected vessel(s), and comparing the temperature to a dew point value input to the SCADA. The site received no rain during the growth period. Plants were initially planted into moist plant growing medium with a moisture content suitable for transplanting small two week old starter seedlings of 1.5-2 inches in height. Plants were harvested and root and medium examined on day 37, Nov. 15, 2013 as pictured in FIGS. 10 and 11.

While the butter lettuce did not have a low temperature cut-off for the soil temperature, in some embodiments it can be desirable to prevent the soil temperature from reaching excessively low temperatures, such as 40, 45, 50 or 55F, depending upon the plants being grown.

Having now described the invention in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

The foregoing Detailed Description of exemplary and preferred embodiments is presented for purposes of illustration and disclosure in accordance with the requirements of the law. The figures are not to scale and have a particular dimension only where expressly indicated. The disclosure is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising the step(s) of . . . . ”

All elements, parts and steps described herein are preferably included. It is to be understood that any of these elements, parts and steps may be replaced by other elements, parts and steps or deleted altogether as will be obvious to those skilled in the art.

Broadly, this writing discloses at least the following: a method and system for growing a plant, the method comprising: exposing a plant to water, growing medium and air; wherein the plant comprises a set of roots and the set of roots are located in the growing medium which is in a plant growth vessel, the plant growth vessel is located within an outer vessel, and a cooling medium is present in a space between an outer wall of the plant growth vessel and a containment wall of the outer vessel, and the cooling medium is in thermal communication with the growing medium through the outer wall, and the plant includes a set of roots and the set of roots are isolated from the cooling medium.

Concepts

Concept 1. Plants are placed in soil or plant growing medium contained in planter vessel(s).

Concept 2. Planter vessels float in fluid medium.

Concept 3. The fluid is contained in reservoir of various shape and size and depth.

Concept 4. Planter vessels can be of various shapes.

Concept 5. Planter vessels can be constructed from various thermal exchanging materials either metallic or non-metallic.

Concept 6. Planter vessels can be held down against buoyancy.

Concept 7. Planter vessels have a perimeter freeboard wall.

Concept 8. The fluid in the reservoir can be open flow system or static.

Concept 9. The fluid can be thermally controlled.

Concept 10. The fluid can be thermally controlled within the reservoir.

Concept 11. The planter vessels' soil or growing medium temperature can be regulated.

Concept 12. Planter soil or growing medium can be made cooler than the ambient dew point temperature to reduce moisture evaporation loss.

Concept 13. Planter soil or growing medium can be thermally increased to induce plant stress.

Concept 14. Planter vessels are designed to encourage plant root development to the inside the vessel wall surface or the coldest area in the planter vessel.

Concept 15. Planter vessels are designed so they can be nested for storage and shipping.

Concept 16. Planter vessels are designed that they can be moved outside the reservoir via conveyor rollers or carts.

Concept 17. A method of growing a plant, the method comprising:
exposing a plant to water, soil or solid growing medium and air;
   wherein the plant comprises a set of roots and the set of roots are located in the soil or solid growing medium which is in a plant growth vessel, the plant growth vessel is located within an outer vessel, and a cooling medium is present in a space between an outer wall of the plant growth vessel and a containment wall of the outer vessel, and
   the cooling medium is in thermal communication with the soil or solid growing medium through the outer wall, and the plant includes a set of roots and the set of roots are isolated from the cooling medium.

Concept 18. The method of Concept 17, wherein the cooling medium is a liquid.

Concept 19. The method of Concept 17, wherein during a portion of a day, the cooling medium temperature is controlled to a temperature of 10 to 15° F. below the dew point of an environment proximate a portion of the plant above the soil or solid growing medium.

Concept 20. The method of Concept 17, wherein the plant growth vessel floats in the cooling medium.

Concept 21. The method of Concept 17, wherein the outer vessel forms a conveyance path and the plant growth vessels are moved from a first point in the conveyance path to a second point in the conveyance path.

Concept 22. The method of Concept 21, wherein the conveyance path forms a loop.

Concept 23. The method of Concept 21, wherein the plants are moved from the first point to the second point by a flow of cooling medium in the conveyance path.

Concept 24. The method of Concept 17, wherein the cooling medium is in turn cooled by a chiller.

Concept 25. The method of Concept 24, wherein the chiller operates off of waste heat.

Concept 26. The method of Concept 24, wherein the chiller operates off of waste heat from a generator which produces CO₂, and at least a portion of the CO₂ is directed to an environment proximate a portion of the plant above the soil or solid growing medium.

Concept 27. The method of Concept 17, wherein the plant growth vessel is configure to allow gasses released from the soil or solid growing medium to pass freely out of the plant growth vessel.

Concept 28. The method of Concept 17, wherein the temperature of the cooling medium is controlled to a point during at least a portion of the day so as to condense water from an environment above the soil or solid growing medium onto the soil or solid growing medium.

Concept 29. The method of Concept 17, wherein the temperature of the cooling medium is controlled to a temperature of about 50° F. (10° C.) to about 60° F. (16° C.) for at least a portion of the day.

Concept 30. The method of Concept 19, wherein during substantially the entire daylight period of the day, the cooling medium temperature is controlled to a temperature of 10 F degrees (6 C degrees) to 15 F degrees (8 C degrees) below the dewpoint of the environment proximate the portion of the plant above the soil or solid growing medium.

Concept 31. The method of Concept 19, wherein during substantially the entire day, the cooling medium temperature is controlled to a temperature of 10 F degrees (6 C degrees) to 15 F degrees (8 C degrees) below the dewpoint of the environment proximate the portion of the plant above the soil or solid growing medium.

Concept 32. The method of Concept 29, wherein the temperature of the cooling medium is controlled to a temperature of about 50° F. (10° C.) to about 60° F. (16° C.) for substantially the entire daylight period of the day.

Concept 33. The method of Concept 29, wherein the temperature of the cooling medium is controlled to a temperature of about 50° F. (10° C.) to about 60° F. (16° C.) for substantially the entire day.

Concept 34. The method of Concept 17, wherein the temperature of an environment proximate a portion of the plant above the soil or solid growing medium is modified by an evaporative cooler.

Concept 35. A system for growing a plant, the system comprising:
a plant rooted in growing medium;
the growing medium contained in a plant growth vessel; and
the plant growth vessel located in an outer vessel;
wherein
a cooling medium is located within the outer vessel and in contact with an outer wall of the plant growth vessel, the outer vessel, plant growth vessel and the cooling medium configured to cool the growing medium and a root of the plant through the outer wall of the plant growth vessel, and the outer wall configured to prevent contact of the cooling medium and the growing medium.

Concept 36. The system of Concept 35 wherein a bottom surface of the plant growth vessel contacts a portion of the outer vessel and a movement of the plant growth vessel is thereby inhibited.

Concept 37. The system of Concept 35, wherein the outer vessel forms a pathway and the plant growth vessels are conducted along the pathway during a growth cycle of the plant.

Concept 38. The system of Concept 37, wherein the pathway forms a loop.

Concept 39. The system of Concept 37 wherein the plant growth vessels are conducted along the pathway by movement of the cooling medium.

Concept 40. The system of Concept 35 further comprising an evaporative cooler configured to cool at least a portion of the environment proximate to a top portion of the plant.

Concept 41. The system of Concept 35, wherein the cooling medium is a fluid.

Concept 42. The system of Concept 41 wherein the fluid is salt water.

Concept 43. A method of directing root growth, the method comprising:
growing a plant in a growing medium in a vessel;
subjecting the growing medium to a temperature gradient wherein the temperature gradient is in a direction of desired root growth.

Concept 44. The method of Concept 43, wherein the temperature gradient is in a downward direction.

Concept 45. The method of Concept 43, wherein the temperature gradient is in an outward direction.

Concept 46. The method of Concept 18, wherein the cooling medium comprises glycol.

Concept 47. The method of Concept 18 wherein the cooling medium comprises water.

Concept 48. The method of Concept 18, wherein the cooling medium substantially consists of water.

Concept 50. The method of Concept 18, wherein the cooling medium is water.

Concept 51. The system of Concept 35, wherein the growing medium comprises soil.

Concept 52. The system of Concept 35, wherein the growing medium is soil.

Concept 53. The system of Concept 35, wherein growing medium is a solid growing medium.

Concept 54. The system of Concept 41, wherein the fluid is water.

Concept 55. The system of Concept 54, wherein the water is salt water.

Concept 56. The system of Concept 41, wherein the fluid comprises glycol.

Concept 57. The system of Concept 41, wherein the fluid is glycol.

Concept 58. A method of growing a plant, the method comprising:
exposing a plant to water, solid growing medium and air;
   wherein the plant comprises a set of roots and the set of roots are located in the solid growing medium which is in a plant growth vessel, the plant growth vessel is located within an outer vessel, and a cooling medium is present in a space between an outer wall of the plant growth vessel and a containment wall of the outer vessel, and
   the cooling medium is in thermal communication with the solid growing medium through the outer wall, and the plant includes a set of roots and the set of roots are isolated from the cooling medium.

Concept 59. The method of Concept 58, wherein the cooling medium is in turn cooled by a chiller.

Concept 60. The method of Concept 59, wherein the chiller operates off of waste heat.

Concept 61. The method of Concept 58 or 59, wherein the chiller operates off of waste heat from a generator which produces CO₂, and at least a portion of the CO₂ is directed to an environment proximate a portion of the plant above the solid growing medium.

Concept 62. The method of any one of Concepts 58-61, wherein the cooling medium is a liquid.

Concept 63. The method of any one of Concepts 58-62, wherein during a portion of a day, the cooling medium temperature is controlled to a temperature of 10 to 15° F. below the dew point of an environment proximate a portion of the plant above the solid growing medium.

Concept 64. The method of Concept 63, wherein during substantially the entire daylight period of the day, the cooling medium temperature is controlled to a temperature of 10 F degrees (6 C degrees) to 15 F degrees (8 C degrees) below the dew point of the environment proximate the portion of the plant above the solid growing medium.

Concept 65. The method of Concept 63 or 64, wherein during substantially the entire day, the cooling medium temperature is controlled to a temperature of 10 F degrees (6 C degrees) to 15 F degrees (8 C degrees) below the dew point of the environment proximate the portion of the plant above the solid growing medium.

Concept 66. The method of any one of Concepts 58-65, wherein the plant growth vessel floats in the cooling medium.

Concept 67. The method of any one of Concepts 58-66, wherein the outer vessel forms a conveyance path and the plant growth vessels are moved from a first point in the conveyance path to a second point in the conveyance path.

Concept 68. The method of Concept 67, wherein the conveyance path forms a loop.

Concept 69. The method of Concept 67 or 68, wherein the plants are moved from the first point to the second point by a flow of cooling medium in the conveyance path.

Concept 70. The method of any one of Concepts 58-69, wherein the plant growth vessel is configure to allow gasses released from the solid growing medium to pass freely out of the plant growth vessel.

Concept 71. The method of any one of Concepts 58-70, wherein the temperature of the cooling medium is controlled to a point during at least a portion of the day so as to condense water from an environment above the solid growing medium onto the solid growing medium.

Concept 72. The method of any one of Concepts 58-71, wherein the temperature of the cooling medium is controlled to a temperature of about 50° F. (10° C.) to about 60° F. (16° C.) for at least a portion of the day.

Concept 73. The method of Concept 72, wherein the temperature of the cooling medium is controlled to a temperature of about 50° F. (10° C.) to about 60° F. (16° C.) for substantially the entire daylight period of the day.

Concept 74. The method of Concept 72 or 73, wherein the temperature of the cooling medium is controlled to a temperature of about 50° F. (10° C.) to about 60° F. (16° C.) for substantially the entire day.

Concept 75. The method of any one of Concepts 58-74, wherein the temperature of an environment proximate a portion of the plant above the solid growing medium is modified by an evaporative cooler.

Concept 76. A system for growing a plant, the system comprising:
a plant rooted in solid growing medium;
the solid growing medium contained in a plant growth vessel; and
the plant growth vessel located in an outer vessel;
wherein
a cooling medium is located within the outer vessel and in contact with an outer wall of the plant growth vessel, the outer vessel, plant growth vessel and the cooling medium configured to cool the solid growing medium and a root of the plant through the outer wall of the plant growth vessel, and the outer wall configured to prevent contact of the cooling medium and the solid growing medium.

Concept 77. The system of Concept 76 wherein a bottom surface of the plant growth vessel contacts a portion of the outer vessel and a movement of the plant growth vessel is thereby inhibited.

Concept 78. The system of Concept 76 or 77, wherein the outer vessel forms a pathway and the plant growth vessels are conducted along the pathway during a growth cycle of the plant.

Concept 79. The system of Concept 78, wherein the pathway forms a loop.

Concept 80. The system of Concept 78 or 79 wherein the plant growth vessels are conducted along the pathway by movement of the cooling medium.

Concept 81. The system of any one of Concepts 76-80 further comprising an evaporative cooler configured to cool at least a portion of the environment proximate to a top portion of the plant.

Concept 82. The system of any one of Concepts 76-81, wherein the cooling medium is water.

Concept 83. The system of Concept 82 wherein the water is salt water.

Concept 84. A method of directing root growth, the method comprising:
growing a plant in a solid growing medium in a vessel;
subjecting the solid growing medium to a temperature gradient wherein the temperature gradient is in a direction of desired root growth.

Concept 85. The method of Concept 84, wherein the temperature gradient is in a downward direction and/or an outward direction.

1. A method of growing a plant, the method comprising:
exposing a plant to water, solid growing medium and air;
wherein the plant comprises a set of roots and the set of roots are located in the solid growing medium which is in a plant growth vessel, the plant growth vessel is located within an outer vessel, and a cooling medium is present in a space between an outer wall of the plant growth vessel and a containment wall of the outer vessel, and
the cooling medium contacts the outer wall and is in thermal communication with the solid growing medium through the outer wall, and the plant includes a set of roots and the set of roots are isolated from the cooling medium.

2. The method of claim 1, wherein the cooling medium is a liquid.

3. The method of claim 1, wherein during a portion of a day, the cooling medium temperature is controlled to a temperature of 10 to 15° F. below the dew point of an environment proximate a portion of the plant above the solid growing medium.

4. The method of claim 1, wherein the plant growth vessel floats in the cooling medium.

5. The method of claim 1, wherein the outer vessel forms a conveyance path and the plant growth vessels are moved from a first point in the conveyance path to a second point in the conveyance path.

6. The method of claim 5, wherein the conveyance path forms a loop.

7. The method of claim 5, wherein the plants are moved from the first point to the second point by a flow of cooling medium in the conveyance path.

8. The method of claim 1, wherein the cooling medium is in turn cooled by a chiller.

9. The method of claim 8, wherein the chiller operates off of waste heat.

10. The method of claim 8, wherein the chiller operates off of waste heat from a generator which produces CO₂, and at least a portion of the CO₂ is directed to an environment proximate a portion of the plant above the solid growing medium.

11. The method of claim 1, wherein the plant growth vessel is configure to allow gasses released from the solid growing medium to pass freely out of the plant growth vessel.

12. The method of claim 1, wherein the temperature of the cooling medium is controlled to a point during at least a portion of the day so as to condense water from an environment above the solid growing medium onto the solid growing medium.

13. The method of claim 1, wherein the temperature of the cooling medium is controlled to a temperature of about 50° F. (10° C.) to about 60° F. (16° C.) for at least a portion of the day.

14. The method of claim 3, wherein during substantially the entire daylight period of the day, the cooling medium temperature is controlled to a temperature of 10 F degrees (6 C degrees) to 15 F degrees (8 C degrees) below the dew point of the environment proximate the portion of the plant above the solid growing medium.

15. The method of claim 3, wherein during substantially the entire day, the cooling medium temperature is controlled to a temperature of 10 F degrees (6 C degrees) to 15 F degrees (8 C degrees) below the dew point of the environment proximate the portion of the plant above the solid growing medium.

16. The method of claim 13, wherein the temperature of the cooling medium is controlled to a temperature of about 50° F. (10° C.) to about 60° F. (16° C.) for substantially the entire daylight period of the day.

17. The method of claim 13, wherein the temperature of the cooling medium is controlled to a temperature of about 50° F. (10° C.) to about 60° F. (16° C.) for substantially the entire day.

18. The method of claim 1, wherein the temperature of an environment proximate a portion of the plant above the solid growing medium is modified by an evaporative cooler.

19. A system for growing a plant, the system comprising:
a plant rooted in solid growing medium;
the solid growing medium contained in a plant growth vessel; and
the plant growth vessel located in an outer vessel;
wherein
a cooling medium is located within the outer vessel and in contact with an outer wall of the plant growth vessel, the outer vessel, plant growth vessel and the cooling medium configured to cool the solid growing medium and a root of the plant through the outer wall of the plant growth vessel, and the outer wall configured to prevent contact of the cooling medium and the solid growing medium.

20. The system of claim 19 wherein a bottom surface of the plant growth vessel contacts a portion of the outer vessel and a movement of the plant growth vessel is thereby inhibited.

21. The system of claim 19, wherein the outer vessel forms a pathway and the plant growth vessels are conducted along the pathway during a growth cycle of the plant.

22. The system of claim 21, wherein the pathway forms a loop.

23. The system of claim 21 wherein the plant growth vessels are conducted along the pathway by movement of the cooling medium.

24. The system of claim 19 further comprising an evaporative cooler configured to cool at least a portion of the environment proximate to a top portion of the plant.

25. The system of claim 19, wherein the cooling medium is water.

26. The system of claim 25 wherein the water is salt water.

27. A method of directing root growth, the method comprising:
growing a plant in a solid growing medium in a vessel;
subjecting the solid growing medium to a temperature gradient wherein the temperature gradient is in a direction of desired root growth.

28. The method of claim 27, wherein the temperature gradient is in a downward direction.

29. The method of claim 27, wherein the temperature gradient is in an outward direction.
